(19) United States
(12) Patent Application Publication
(10) Pub. No.: US 2025/0377623 A1
(43) Pub. Date: Dec. 11, 2025

(54) IMAGE FORMING APPARATUS AND IMAGE FORMING SYSTEM THAT FORM ADHESIVE IMAGE USING ADHESIVE

(71) Applicant: CANON KABUSHIKI KAISHA, Tokyo (JP)

(72) Inventor: Hirotaka Shiomichi, Kanagawa (JP)

(21) Appl. No.: 19/227,742

(22) Filed: Jun. 4, 2025

(30) Foreign Application Priority Data
Jun. 11, 2024 (JP) 2024-094509

(51) Int. Cl. G03G 15/00

(52) U.S. Cl. CPC G03G 15/6544; G03G 2215/00734; G03G 2215/00742; G03G 2215/00822

(57) ABSTRACT

An image forming apparatus includes: an image forming unit configured to form an image on a sheet based on first image data; and a control unit configured to generate the first image data and output the first image data to the image forming unit, wherein the control unit is further configured to, in a case where the image including an adhesive image used as an adhesive is to be formed on the sheet in response to reception of a print job in which a plurality of sheets are bonded together by forming the image thereon, decide on a density of the adhesive image based on a type of the sheet.

### BACKGROUND

### Field of the Technology

The present disclosure relates to an image forming apparatus, and to an image forming system that includes this image forming apparatus and a processing apparatus.

### Description of the Related Art

An image forming system including an image forming apparatus that forms images on sheets, and a processing apparatus that creates a booklet by bonding together a plurality of sheets on which images have been formed by this image forming apparatus, has been used. Japanese Patent Laid-Open No. 2005-215230 discloses a configuration in which sheets are bonded to each other by forming, on the sheets, an adhesive image that is based on toner used as an adhesive. According to Japanese Patent Laid-Open No. 2005-215230, in order to secure an adhesive force between sheets, the number of sheets to be bonded together at a time is controlled in accordance with a sheet type.

The adhesive force between sheets increases with an increase in the amount of the adhesive applied to the sheets, that is to say, the density of an adhesive image. However, if the density of the adhesive image is increased beyond necessity, toner used as the adhesive is wastefully consumed. On the other hand, if the density of the adhesive image is overly reduced, a required adhesive force cannot be secured.

### SUMMARY

According to an aspect of the present disclosure, an image forming apparatus includes: an image forming unit configured to form an image on a sheet based on first image data; and a control unit configured to generate the first image data and output the first image data to the image forming unit, wherein the control unit is further configured to, in a case where the image including an adhesive image used as an adhesive is to be formed on the sheet in response to reception of a print job in which a plurality of sheets are bonded together by forming the image thereon, decide on a density of the adhesive image based on a type of the sheet.

Features of the present disclosure will become apparent from the following description of embodiments with reference to the attached drawings. The following description of embodiments are described by way of example.

### BRIEF DESCRIPTION OF THE DRAWINGS

FIG. 1 is a schematic configuration diagram of an image forming system according to some embodiments.

FIG. 2A and FIG. 2B are diagrams showing examples of an adhesive image according to some embodiments.

FIG. 3A and FIG. 3B are explanatory diagrams of adhesion processing according to some embodiments.

FIG. 4 is a diagram of a control configuration of an image forming system according to some embodiments.

FIG. 5A is a configuration diagram of a type detection sensor according to some embodiments.

FIG. 5B is a diagram showing examples of detections of sheet types according to some embodiments.

FIG. 6 is a diagram showing an example of determination information according to some embodiments.

FIG. 7 is a flowchart of image forming processing according to an embodiment.

FIG. 8 is a timing chart of image forming processing according to an embodiment.

FIG. 9 is a flowchart of image forming processing according to an embodiment.

FIG. 10 is a flowchart of image forming processing according to an embodiment.

FIG. 11 is a diagram of a control configuration of an image forming system according to some embodiments.

FIG. 12 is a diagram showing examples of a user image region and adhesive image regions.

FIG. 13 is a flowchart of image forming processing according to an embodiment.

FIG. 14A and FIG. 14B are timing charts of image forming processing according to an embodiment.

FIG. 15 is a flowchart of image forming processing according to an embodiment.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### First Embodiment

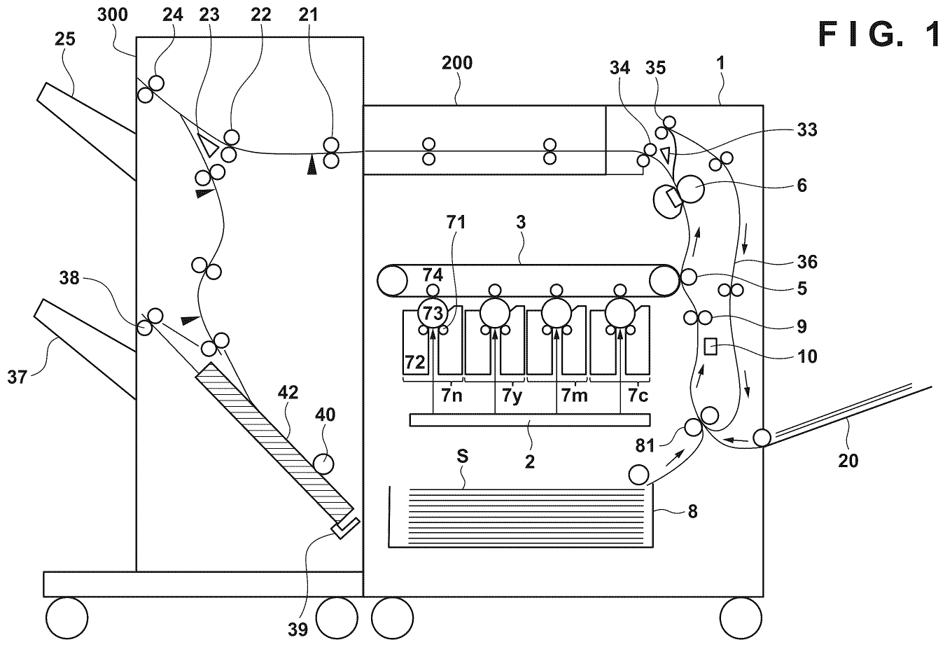

FIG. 1 is a diagram showing an example of a schematic configuration of an image forming system according to the present embodiment. The image forming system includes an image forming apparatus 1, an intermediate conveyance unit 200, and a processing apparatus 300. The image forming apparatus 1 includes four process units 7n, 7y, 7m, and 7c. The process units 7y, 7m, and 7c respectively include yellow, magenta, and cyan toners, and form yellow, magenta, and cyan toner images on an intermediate transfer belt 3. The process unit 7n includes toner used as a powder adhesive, and forms a toner image that is based on this toner on the intermediate transfer belt 3. The toner used as the powder adhesive can have any color, or can be transparent. In the following description, in a case where an image formed by the process unit 7n is distinguished from images formed by the process units 7y, 7m, and 7c, the image formed by the process unit 7n is referred to as an adhesive image, and the images formed by the process units 7y, 7m, and 7c are referred to as user images. Furthermore, the adhesive image and the user images are collectively referred to as “toner images”, or simply as “images”.

Note that in the present embodiment, the process unit 7n is used only for formation of the adhesive image. However, for example, when the process unit 7n contains black toner that can be used also as an adhesive, a configuration can be realized in which the process unit 7n is used also in formation of a user image.

As the configurations of the process units 7n, 7y, 7m, and 7c are similar to one another, the configuration of the process unit 7n will be described below as a representative. At the time of image formation, a photosensitive member 73 is driven to rotate in a clockwise direction in the figure. A charging roller 71 charges the surface of the photosensitive member 73 to a uniform potential. Based on image data, an exposure unit 2 scans the photosensitive member 73 that is driven to rotate, and exposes the photosensitive member 73 to light, for each line in a main-scanning direction, thereby forming an electrostatic latent image on the photosensitive member 73. The main-scanning direction is a direction in which the exposure unit 2 causes light based on image data to move on the photosensitive member 73, and corresponds to a direction of a rotation axis of the photosensitive member 73. A developing unit 72 forms a toner image on the photosensitive member 73 by developing the electrostatic latent image formed on the photosensitive member 73 with use of toner. A primary transfer roller 74 transfers the toner image on the photosensitive member 73 to the intermediate transfer belt 3, which is driven to rotate in a counterclockwise direction in the figure, by outputting a primary transfer voltage. Colors different from yellow, magenta, and cyan are reproduced by transferring the toner images that have been formed on the photosensitive members 73 of the respective process units 7y, 7m, and 7c to the intermediate transfer belt 3 in such a manner that the toner images are laid over one another. In the present embodiment, as black toner is not used, the color black is reproduced by laying yellow, magenta, and cyan toners over one another. However, as stated earlier, the process unit 7n can be used also in formation of a black toner image. The toner images transferred to the intermediate transfer belt 3 are conveyed to a position opposing a secondary transfer roller 5 as a result of rotation of the intermediate transfer belt 3.

The secondary transfer roller 5 transfers the toner images on the intermediate transfer belt 3 to a sheet S conveyed from a cassette 8 or a tray 20 by outputting a secondary transfer voltage. Note that a roller 81 conveys the sheet S that has been fed from the cassette 8 or the tray 20 to a conveyance path in the image forming apparatus 1 in a direction toward a registration roller 9 located on the downstream side. The registration roller 9 sends the sheet S to the position opposing the secondary transfer roller 5 while adjusting a timing so that the toner images on the intermediate transfer belt 3 are transferred to the sheet S. A fixing unit 6 applies heat and pressure to the sheet S to which the toner images have been transferred, thereby fixing the toner images on the sheet S. In a case where an image is formed only on one surface (a first surface) of the sheet S, the sheet S on which the toner images have been fixed is directed by a guide 33 to a conveyance path provided with a roller 34. Then, the roller 34 conveys the sheet S toward the intermediate conveyance unit 200. The intermediate conveyance unit 200 conveys the sheet S to the processing apparatus 300.

In a case where an image is formed on both surfaces of the sheet S, after the toner images on the first surface have been fixed, the sheet S is directed by the guide 33 to a conveyance path provided with a roller 35. At a timing when the trailing edge of the sheet S has reached the roller 35, the rotation direction of the roller 35 is reversed. Accordingly, the sheet S is conveyed to the position opposing the secondary transfer roller 5 again via a double-side conveyance path 36, and toner images are transferred to a second surface thereof. Once the toner images have been transferred to the second surface, the fixing unit 6 fixes the toner images on the sheet S. Thereafter, the sheet S is directed by the guide 33 to the conveyance path provided with the roller 34, and conveyed to the processing apparatus 300 via the intermediate conveyance unit 200.

The process units 7n, 7y, 7m, and 7c, the exposure unit 2, the intermediate transfer belt 3, the secondary transfer roller 5, and the fixing unit 6 compose an image forming unit that forms an image on a sheet. Note that the image forming apparatus 1 is not limited to forming an image on a sheet via the intermediate transfer belt 3, and may form an image on a sheet without intervention of the intermediate transfer belt 3. Also, the image forming apparatus 1 is not limited to forming a color image, and may form a monochrome image. In this case, the image forming apparatus 1 includes a process unit for forming an adhesive image, and a process unit for forming a user image. Note that in a case where toner for forming a user image is the same as toner for forming an adhesive image, one process unit can be provided in the image forming apparatus 1. A type detection sensor 10 detects a characteristic of a sheet S at the upstream side of the registration roller 9. In the present embodiment, the characteristic of the sheet S is represented by the basis weight and the surface property of the sheet S.

The sheet S conveyed from the intermediate conveyance unit 200 to the processing apparatus 300 is conveyed to the downstream side by an entrance roller 21. In a case where adhesion processing is not executed for the sheet S, the sheet S is discharged to an upper tray 25 by a pre-buffer roller 22 and an inversion roller 24. On the other hand, in a case where adhesion processing is executed for the sheet S, after the trailing edge of the sheet S has gone past a guide 23, the rotation direction of the inversion roller 24 is reversed from the rotation direction up till then; as a result, the sheet S is conveyed toward a processing unit 42. Note that, at this time, the guide 23 is set to be in a state where it directs the sheet S to the processing unit 42.

Once the sheet S has been conveyed to the processing unit 42, a roller 40 provided in the processing unit 42 causes the sheet S to abut a vertical alignment reference plate 39 in the processing unit 42; in this way, processing for aligning one or more sheets loaded in the processing unit 42 is executed. Each time a predetermined number of sheets are newly conveyed to the processing unit 42, the processing unit 42 executes the adhesion processing and creates a booklet. The created booklet is pushed by the vertical alignment reference plate 39 in a direction toward a bundle discharge roller 38, and is discharged to a lower tray 37 by the bundle discharge roller 38.

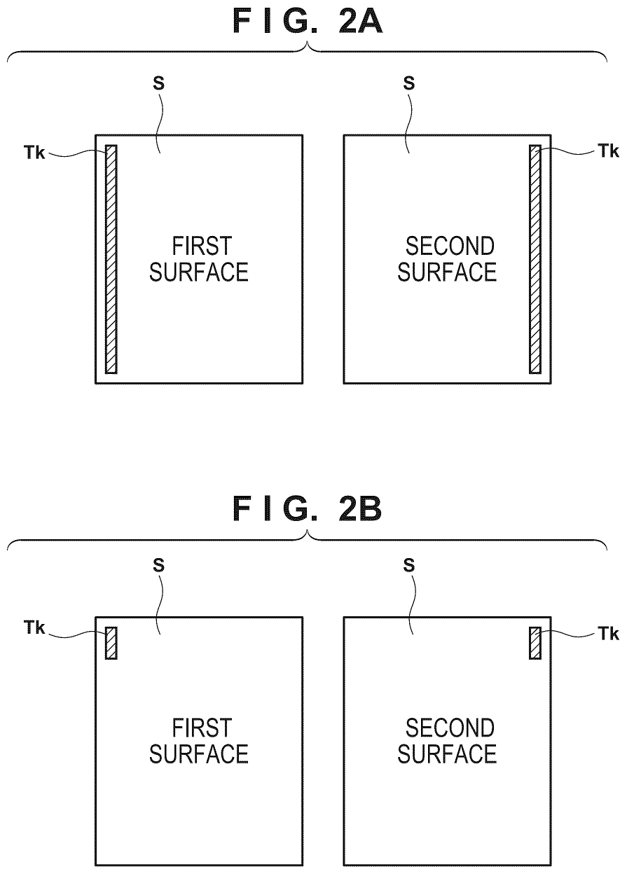

FIG. 2A and FIG. 2B show examples of an adhesive image Tk. In FIG. 2A and FIG. 2B, a “first surface” denotes a sheet surface on which an image is formed first in double-sided image formation, and a “second surface” denotes a surface different from the first surface. By forming the adhesive image Tk on an end portion along a long edge of a sheet S as shown in FIG. 2A, a booklet bound at a long edge can be produced by the adhesion processing in the processing apparatus 300. Also, by forming the adhesive image Tk on a part of an end portion along a long edge of a sheet S as shown in FIG. 2B, a booklet bound at a corner can be produced by the adhesion processing in the processing apparatus 300.

Note that the adhesive image Tk is formed only on a surface that opposes another sheet S when loaded in the processing unit 42. Therefore, with regard to sheets S at both ends of a booklet, the adhesive image Tk is formed on one side only. Also, in the present embodiment, when sheets S are loaded in the processing unit 42, the adhesive image Tk is formed on both of a top surface of a first sheet and a bottom surface of a second sheet situated above the first sheet. However, it is permissible to adopt a configuration in which the adhesive image Tk is formed on only one of the top surface of the first sheet and the bottom surface of the second sheet. Information indicating a plurality of patterns of the adhesive image Tk shown in FIG. 2A and FIG. 2B is stored in advance in the image forming apparatus 1.

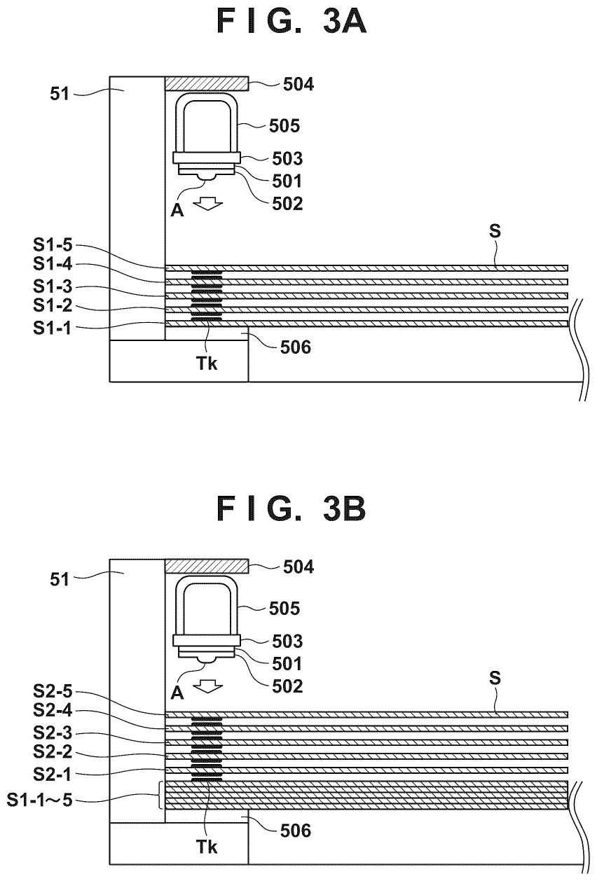

Next, the adhesion processing in the processing unit 42 will be described. FIG. 3A and FIG. 3B are cross-sectional diagrams of the processing unit 42 for a case where the processing unit 42 is viewed from the vertical alignment reference plate 39 of FIG. 1 along a direction parallel to a conveyance direction of sheets S. A ceramic heater 501 with a built-in heat generator is supported by a heater support 503 made of resin, and applies heat to a heating plate 502 made of aluminum. Note that the temperature of the ceramic heater 501 is controlled based on the temperature detected by a non-illustrated temperature sensor. Also, the heating plate 502 includes a pressurizing unit A. A pressurizing lever 504 presses down the heater support 503, the ceramic heater 501, and the heating plate 502, via a metallic stay 505 as a rigid body, in a downward direction in FIG. 3A and FIG. 3B, that is to say, in a direction along which the sheets S are loaded. As a result, the heating plate 502 applies heat and pressure to the sheets S loaded in the processing unit 42. Note that a pressurizing plate 506 for catching a pressurizing force by the heating plate 502 is provided at the opposite side of the sheets S from the heating plate 502. The pressurizing plate 506 is composed of silicone rubber and the like.

FIG. 3A shows a state where five sheets, namely sheets S1-1 to S1-5, are loaded in the processing unit 42. As shown in FIG. 3A, the adhesive image Tk is formed in a region where heat and pressure are applied by the heating plate 502. In the state shown in FIG. 3A, the heating plate 502 applies heat and pressure to the five sheets S; in this way, the adhesive image Tk is melted, and the adhesion processing is executed. FIG. 3B shows a state where five sheets S2-1 to S2-5 are newly loaded on top of the sheets S1-1 to S1-5 to which the adhesion processing has been applied. In the state shown in FIG. 3B, the heating plate 502 applies heat and pressure to the loaded sheets S; in this way, the ten sheets S are bonded together.

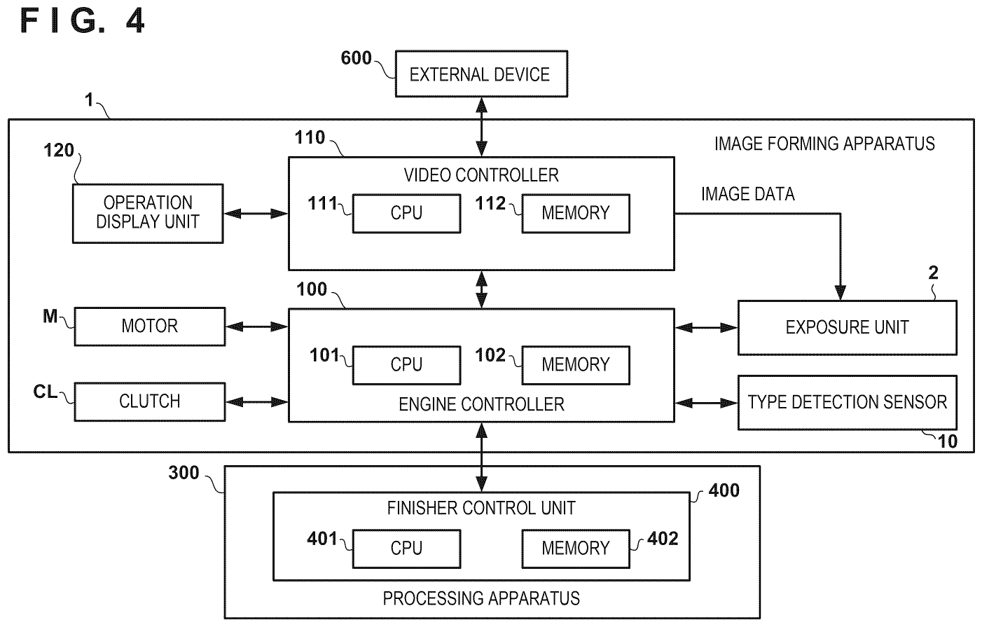

FIG. 4 shows an example of a schematic hardware configuration of the image forming system. The image forming apparatus 1 includes a video controller 110 and an engine controller 100, and the processing apparatus 300 includes a finisher control unit 400. The video controller 110 and the engine controller 100 compose a control unit of the image forming apparatus 1. The video controller 110, the engine controller 100, and the finisher control unit 400 are connected to one another, and control the operations of the image forming system in coordination with one another.

The video controller 110 includes a central processing unit (CPU) 111 and a memory 112. The CPU 111 performs integrated control on the image forming apparatus 1 by reading out and executing a program stored in the memory 112. The memory 112 includes a nonvolatile storage medium, such as a read-only memory (ROM), and a volatile storage medium, such as a random-access memory (RAM). The memory 112 acts as a location in which the program and data are kept, and also acts as a working space when the CPU 111 executes the program. The memory 112 is an example of a non-transitory computer-readable storage medium storing a program.

The video controller 110 is configured to be capable of communicating with an external device 600, such as a personal computer and a mobile information device, and accepts, for example, a command for executing a print job from the external device 600. In response to reception of a print job from the external device 600, the CPU 111 causes the engine controller 100 to perform image formation that is based on this print job. At this time, based on image information received together with the print job, the CPU 111 generates image data to be output to the exposure unit 2. The image data is data that is used by the exposure unit 2 to form electrostatic latent images on the photosensitive members 73, and can be in the form of a pulse-width modulation (PWM) signal, for example. Note that in a case where the print job includes an instruction for execution of the adhesion processing by the processing apparatus 300, the CPU 111 generates the image data so that not only a user image indicated by the image information received together with the print job, but also an adhesive image Tk, are formed. Note that as stated earlier, information indicating a plurality of patterns of the adhesive image Tk is stored in advance in, for example, the memory 112, and the print job designates in which pattern the adhesive image Tk is to be formed.

Also, the video controller 110 is connected to an operation display unit 120, which is a user interface of the image forming system. The operation display unit 120 includes a display apparatus that presents information to a user, such as a liquid crystal panel, and an input apparatus that accepts an input operation performed by the user, such as a touch panel function unit with physical buttons and a liquid crystal panel. The CPU 111 controls the contents displayed on the display apparatus and receives information input via the input apparatus by communicating with the operation display unit 120.

The engine controller 100 includes a CPU 101 and a memory 102. The CPU 101 executes necessary control by reading out and executing a program stored in the memory 102. The memory 102 includes a nonvolatile storage medium and a volatile storage medium. The memory 102 acts as a location in which the program and data are kept, and also acts as a working space when the CPU 101 executes the program. The memory 102 is an example of a non-transitory computer-readable storage medium storing a program.

When the video controller 110 has issued an instruction for image formation, the CPU 101 forms an image on a sheet S by controlling each member of the image forming apparatus 1 that has been described using FIG. 1. In FIG. 4, only the exposure unit 2 and the type detection sensor 10 that have been described using FIG. 1 are shown, and other members are omitted. As shown in FIG. 4, the engine controller 100 controls a motor M and a clutch CL, which are omitted in FIG. 1. The motor M is a driving source of the roller 81 and the registration roller 9. The clutch CL is set to be in a transmission state where the driving force of the motor M is transmitted to the registration roller 9, or in a non-transmission state where the driving force of the motor M is not transmitted to the registration roller 9. The CPU 101 can control the rotation of the registration roller 9 by controlling the state of the clutch CL. Also, the CPU 101 obtains a detection result of the type detection sensor 10, and determines a type of a sheet S.

The finisher control unit 400 includes a CPU 401 and a memory 402. The CPU 401 performs integrated control on the processing apparatus 300 by reading out and executing a program stored in the memory 402. The memory 402 includes a nonvolatile storage medium and a volatile storage medium. The memory 402 acts as a location in which the program and data are kept, and also acts as a working space when the CPU 401 executes the program. The memory 402 is an example of a non-transitory computer-readable storage medium storing a program.

Note that the discrete functions included in the video controller 110, the engine controller 100, and the finisher control unit 400 can be implemented as software by causing each CPU to execute an appropriate program as stated earlier. However, a part or all of the discrete functions included in the video controller 110, the engine controller 100, and the finisher control unit 400 can also be implemented as hardware with use of an application-specific integrated circuit (ASIC) and the like. Furthermore, it is also possible that the video controller 110 bears a part or all of the functions controlled by the engine controller 100. Alternatively, it is also possible that the engine controller 100 bears a part or all of the functions controlled by the video controller 110.

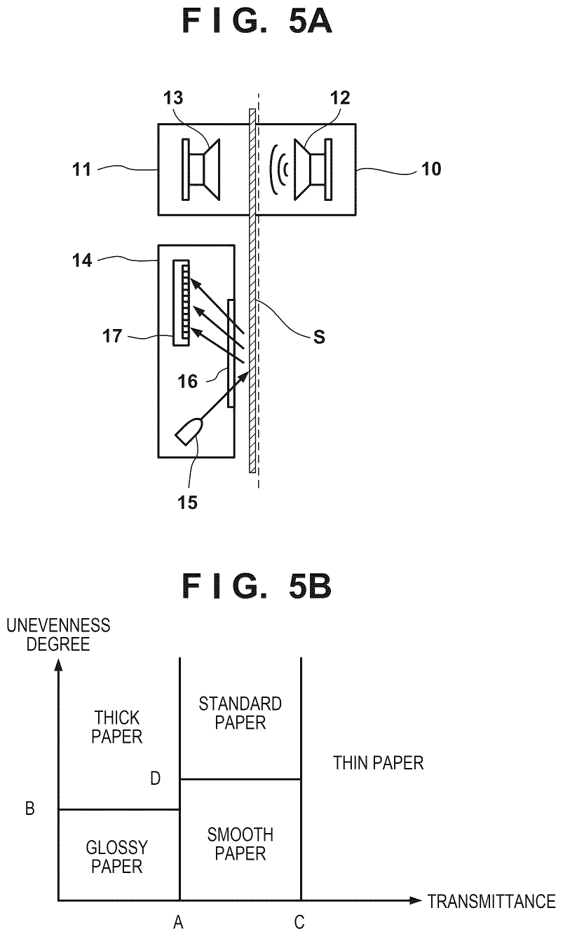

FIG. 5A shows an example of a configuration of the type detection sensor 10. The type detection sensor 10 includes a basis weight detection unit 11 for detecting the basis weight of a sheet S, and a surface property detection unit 14 for detecting the surface property of the sheet S. The basis weight detection unit 11 includes a transmission unit 12 that transmits ultrasound waves, and a reception unit 13 that receives the ultrasound waves. The reception unit 13 receives the ultrasound waves transmitted by the transmission unit 12, and outputs a voltage corresponding to the level (sound pressure) of the received ultrasound waves to the CPU 101. The CPU 101 obtains a first level of the ultrasound waves received by the reception unit 13 when no sheet S exists between the transmission unit 12 and the reception unit 13, and a second level of the ultrasound waves received by the reception unit 13 when a sheet S exists between the transmission unit 12 and the reception unit 13. The CPU 101 can determine the basis weight of the sheet S from the ratio of the second level to the first level (the transmittance). Note that the lower the transmittance, the larger the basis weight.

The surface property detection unit 14 includes an LED 15 as a light source, a light collecting lens 16, and a line sensor 17. The LED 15 is a light source that irradiates a surface of a sheet S with light. The light collecting lens 16 is an optical system that directs reflected light from the sheet S to the line sensor 17. In a case where an LED with great directivity is used, the light collecting lens 16 can be omitted. The line sensor 17 is an image sensor in which a plurality of light receiving elements are arranged in line in a direction perpendicular to a conveyance direction of the sheet S. The line sensor 17 measures the light reception intensity of reflected light from the sheet S in each light receiving element.

The surface property is obtained based on an unevenness degree (a magnitude of a shading difference in a captured image). That is to say, a surface image of the sheet S is obtained by repeatedly measuring the light reception intensity in each pixel of the line sensor 17 while conveying the sheet S. The CPU 101 calculates the unevenness degree of the sheet S on the basis of a shading difference in the obtained surface image, and determines the surface property of the sheet S.

The CPU 101 determines a type of the sheet S on the basis of the basis weight (transmittance) and the unevenness degree. FIG. 5B shows an example of a relationship between combinations of the transmittance and the unevenness degree and sheet types. Information indicating the correspondence relationship between detection results of the type detection sensor 10 and sheet types shown in FIG. 5B is stored in advance in the memory 102. According to FIG. 5B, in a case where the transmittance is lower than a threshold A and the unevenness degree is lower than a threshold B, the type is determined to be “glossy paper”. In a case where the transmittance is lower than the threshold A and the unevenness degree is equal to or higher than the threshold B, the type is determined to be “thick paper”. Also, in a case where the transmittance is equal to or higher than the threshold A and lower than a threshold C and the unevenness degree is lower than a threshold D, the type is determined to be “smooth paper”. Furthermore, in a case where the transmittance is equal to or higher than the threshold A and lower than the threshold C and the unevenness degree is equal to or higher than the threshold D, the type is determined to be “standard paper”. Moreover, in a case where the transmittance is equal to or higher than the threshold C, the type is determined to be “thin paper”.

The CPU 101 notifies the CPU 111 in the video controller 110 of the determined type of the sheet S. Here, on a sheet S with a relatively high unevenness degree, such as thick paper and standard paper, unevenness in applied toner easily occurs due to the influence of unevenness on a surface. If unevenness in applied toner occurs, the adhesion property of the adhesive image Tk decreases. Therefore, with respect to a sheet S with a relatively high unevenness degree, it is necessary to increase the amount of toner applied for the adhesive image Tk. On the other hand, on a sheet S with a low unevenness degree, such as glossy paper and smooth paper, the adhesion property can be secured even if the amount of toner applied for the adhesive image Tk is reduced. Also, on a sheet S with a large basis weight (low transmittance), such as thick paper and glossy paper, a section of adhesion between sheets is easily peeled off due to its high degree of stiffness. Therefore, with respect to a sheet S with a large basis weight, it is necessary to increase the amount of toner applied for the adhesive image Tk to secure the adhesion property.

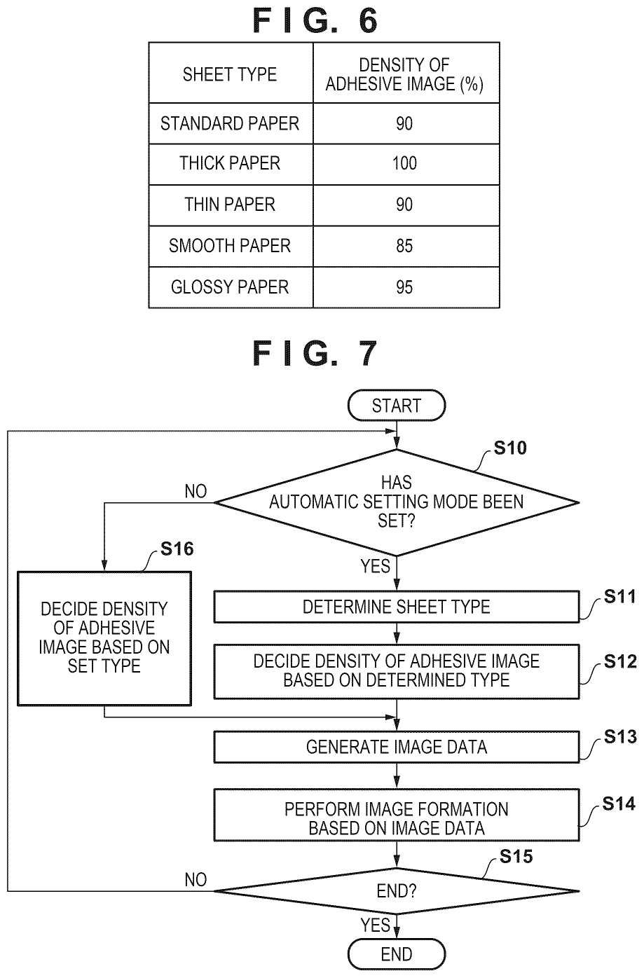

Therefore, in the present embodiment, the CPU 111 of the video controller 110 decides on the amount of toner applied for an adhesive image Tk, that is to say, the image density of an adhesive image Tk, in accordance with a type of a sheet S. FIG. 6 shows an example of determination information stored in the memory 112 of the video controller 110. The determination information is information indicating a correspondence relationship between sheet types and image densities of an adhesive image Tk. Note that in FIG. 6, the maximum density of an image formed on a sheet S is 100%. According to FIG. 6, for example, an adhesive image Tk having a density of 90% is formed on a standard paper.

FIG. 7 is a flowchart of processing executed by the image forming apparatus 1 when the image forming apparatus 1 executes a print job that involves booklet creation in the processing apparatus 300. Note, it is assumed that the image forming apparatus 1 is configured to be capable of turning an automatic setting mode ON or OFF. In a case where the automatic setting mode is ON, the engine controller 100 determines a sheet type with use of the type detection sensor 10, and the video controller 110 decides on a density of an adhesive image Tk on the basis of the sheet type determined by the engine controller 100. On the other hand, in a case where the automatic setting mode is OFF, a user sets a sheet type, and the engine controller 100 decides on the density of the adhesive image Tk on the basis of the sheet type set by the user.

In step S10, the video controller 110 determines whether the automatic setting mode has been set. In a case where the automatic setting mode has not been set (in a case where the automatic setting mode is OFF), the video controller decides on the density of the adhesive image Tk on the basis of a set type that has been set by the user as a type of a sheet S in step S16. On the other hand, in a case where the automatic setting mode has been set (in a case where the automatic setting mode is ON), once the sheet S has reached a detection position of the type detection sensor 10, the engine controller 100 determines the type of the sheet S with use of the type detection sensor 10 in step S11. Then, the engine controller 100 notifies the video controller 110 of the type of the sheet S in step S11. Based on the sheet type (determined type) determined by the engine controller 100, the video controller 110 decides on the density of the adhesive image Tk in step S12.

In step S13, the video controller 110 generates image data to be transmitted to the exposure unit 2. In a case where the adhesive image Tk is to be formed on the first surface of the sheet S, the image data is data for forming both of the adhesive image Tk and a user image that is based on an image signal received through a print job on the sheet S, and the density of the adhesive image Tk is the density decided in step S12 or S16. In step S14, the engine controller 100 notifies the video controller 110 of a timing to transmit the image data to the exposure unit 2, and also performs image formation on the first surface of the sheet S by controlling the light emission intensity of the exposure unit 2. Note that although not shown in FIG. 7 for simplicity of drawings, in a case where the adhesive image Tk is to be formed on the second surface of the sheet S, which is different from the first surface, the density of the adhesive image Tk to be formed on the second surface is also the density decided in step S12 or S16. The image forming apparatus 1 determines whether image formation on all sheets S designated in the print job has been completed in step S15; in a case where the image formation has not been completed, processing from step S10 is repeated until the image formation is completed.

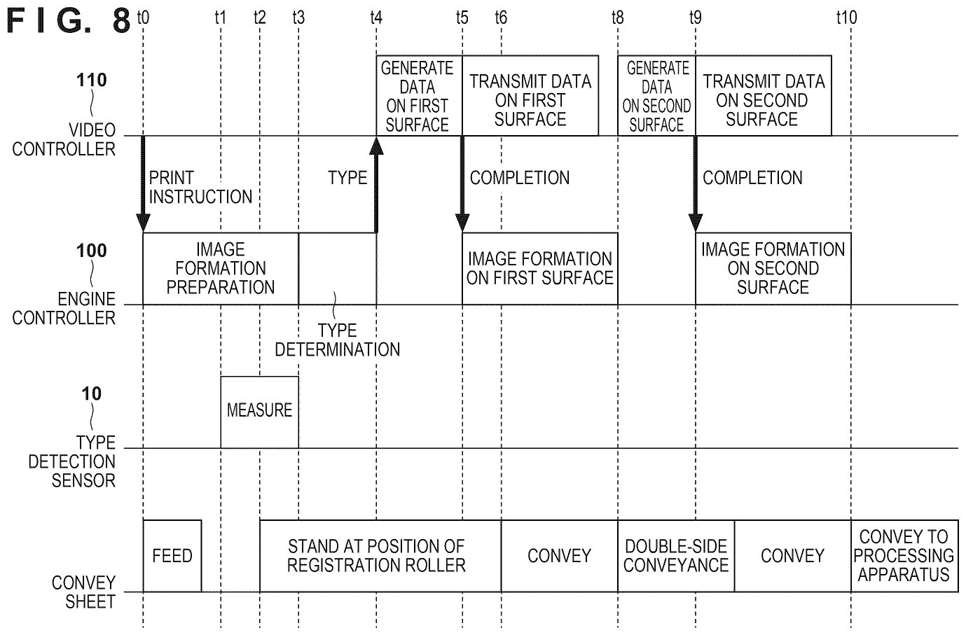

FIG. 8 shows a timing chart for a case where the image forming apparatus 1 executes a print job that involves booklet creation in the processing apparatus 300. Note that FIG. 8 is a chart during a time period from when an image is formed on both surfaces of the first sheet S to when the first sheet S is conveyed toward the processing apparatus 300, and it is assumed that the image forming apparatus 1 is set to be in the automatic setting mode.

Upon receiving a print job at time to, the video controller 110 issues a print instruction to the engine controller 100. In response to the print instruction, the engine controller 100 starts preparation operations for image formation; for example, it starts to drive rotation members, such as the photosensitive members 73, and starts to heat the fixing unit 6. Also, the engine controller 100 starts to feed a sheet S.

At time t1, when the sheet S has reached the detection position of the type detection sensor 10, the engine controller 100 causes the type detection sensor 10 to measure the sheet S. Upon obtaining a measurement result from the type detection sensor 10 at time t3, the engine controller 100 determines a type of the sheet S, and notifies the video controller 110 of the type of the sheet S at time t4. Note that the leading edge of the sheet S reaches the position of the registration roller 9 at time t2, and the engine controller 100 stops the conveyance of the sheet S at this position.

When notified of the sheet type at time t4, the video controller 110 determines a density of an adhesive image Tk on the basis of the sheet type, and generates image data for image formation on the first surface of the sheet S. Upon completion of generation of the image data at time t5, the video controller 110 notifies the engine controller 100 of the completion of generation of the image data.

Upon receiving the notification of the completion of generation of the image data from the video controller 110, the engine controller 100 notifies the video controller 110 of a timing to transmit the image data to the exposure unit 2. Consequently, the video controller 110 transmits the image data to the exposure unit 2. Also, the engine controller 100 controls the members shown in FIG. 1 so that an image is formed on the sheet S on the basis of the image data transmitted to the exposure unit 2 by the video controller 110. According to FIG. 8, the registration roller 9 restarts the conveyance of the sheet S and conveys the sheet S toward the position opposing the secondary transfer roller 5 at time t6.

Upon completion of image formation on the first surface of the sheet S at time t8, the video controller 110 generates image data for image formation on the second surface of the sheet S. Upon completion of generation of the image data at time t9, the video controller 110 notifies the engine controller 100 of the completion of generation of the image data.

Upon receiving the notification of completion of generation of the image data from the video controller 110, the engine controller 100 notifies the video controller 110 of a timing to transmit the image data to the exposure unit 2. Consequently, the video controller 110 transmits the image data to the exposure unit 2. Also, the engine controller 100 controls the members shown in FIG. 1 so that an image is formed on the sheet S on the basis of the image data transmitted to the exposure unit 2 by the video controller 110. Upon completion of image formation on the second surface at time t10, the engine controller 100 conveys the sheet S toward the processing apparatus 300.

As described above, according to the present embodiment, a density of an adhesive image Tk is controlled based on a type of a sheet S. Therefore, the density of the adhesive image Tk can be controlled appropriately.

### Second Embodiment

Next, a second embodiment will be described with a focus on the differences from the first embodiment. According to the first embodiment, in a case where the automatic setting mode has been set, the video controller 110 generates image data after the engine controller 100 has determined a sheet type. In other words, until the engine controller 100 determines a sheet type, the video controller 110 stands by without generating image data. In the present embodiment, in the case of the automatic setting mode, the video controller 110 starts to generate image data assuming that a density of an adhesive image Tk is a first density before the engine controller 100 determines a sheet type. Then, in a case the density of the adhesive image Tk that is based on a type of a sheet S determined by the engine controller 100 (a determined type) is the first density, the image data that was started to be generated in advance is used in image formation. On the other hand, in a case where a density decided based on the determined type (hereinafter, a decided density) is not the first density, the video controller 110 re-generates image data on the basis of the decided density, and uses the re-generated image data in image formation.

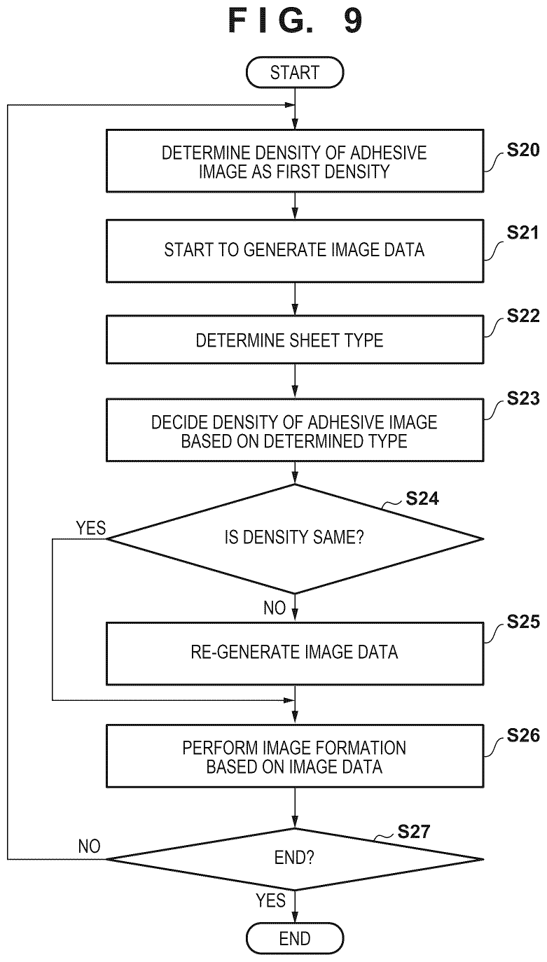

FIG. 9 is a flowchart of processing executed by the image forming apparatus 1 when the image forming apparatus 1 executes a print job that involves booklet creation in the processing apparatus 300. Note that the operations of the image forming apparatus 1 for a case where the automatic setting mode has not been set are similar to those of the first embodiment; therefore, processing for a case where the automatic setting mode has not been set is omitted in the flowchart of FIG. 9. In other words, FIG. 9 shows a flowchart of processing executed by the image forming apparatus 1 in the case of the automatic setting mode.

Upon receiving a print job, the video controller 110 assumes that a density of an adhesive image Tk is the first density in step S20, and starts to generate image data in step S21. In step S22, the engine controller 100 determines an actual type of a sheet S, and notifies the video controller 110 of the same. In step S23, the video controller 110 decides on a density of the adhesive image Tk (a decided density) on the basis of the sheet type determined by the engine controller 100. In step S24, the video controller 110 determines whether the decided density is the same as the first density. In a case where the decided density and the first density are the same, the image data that was started to be generated in step S21 is used in image formation in step S26. On the other hand, in a case where the decided density is different from the first density, the video controller 110 re-generates image data on the basis of the decided density in step S25. In this case, the image data generated in step S25 is used in image formation in step S26.

Note that it is permissible to adopt a configuration in which the image data that was started to be generated in step S21 is used in step S26 in a case where the decided density is within a predetermined range relative to the first density, and the image data generated in step S25 is used in step S26 in other cases.

The video controller 110 determines whether image formation on all sheets S designated in the print job has been completed in step S27; in a case where the image formation has not been completed, processing from step S20 is repeated until the image formation is completed. Although image formation on the second surface is omitted also in FIG. 9, in a case where the adhesive image Tk is to be formed on the second surface, the density decided in step S23 is used as the density of the adhesive image Tk.

Note, in a case where images are to be formed on N sheets S (where N is an integer equal to or larger than two) in the print job, the first density in image formation on the second or subsequent sheet S can be the density of the adhesive image Tk formed on an immediately preceding sheet S. Note, it is assumed that the first density in image formation on the first sheet S is the density that is decided based on a predetermined reference. That is to say, in repeating the flowchart of FIG. 9 N times, the first density used in the first step S20 can be the density that is decided based on the predetermined reference, and the first density used in the second or subsequent step S20 can be the decided density in an immediately preceding step S23. In general, the same sheet type is used in one print job; therefore, by using a previous decided density as the first density used in the second or subsequent step S20, the number of times image data is re-generated (step S25) can be reduced.

The first density used in the first step S20 can be a density set as a default, or a density based on the type of the sheet S set by a user. Alternatively, the first density used in the first step S20 can be a density based on a history of sheet types that were used in past printing. For example, the first density used in the first step S20 can be a decided density corresponding to a sheet type that was used in an immediately preceding print job. Alternatively, the first density used in the first step S20 can be a decided density corresponding to a sheet type that was used most in a predetermined time period of the past.

As described above, in the present embodiment, before a sheet type is determined, generation of image data is started assuming that a density of an adhesive image Tk is the first density. By appropriately setting the first density, the frequency at which image data is re-generated in step S25 can be lowered. As a result, an average time period from reception of a print job to actual image formation on a sheet S can be shortened.

### MODIFIED EMBODIMENT

In the flowchart of FIG. 9, the density of the adhesive image Tk based on the determined type is compared with the predetermined first density in step S24. However, in a case where the first density is a density based on a type of a sheet S that has been set in advance, it is permissible to adopt a configuration in which the determined type is compared with the type of the sheet S that has been set in advance (hereinafter, a set type).

FIG. 15 is a flowchart according to the present modified embodiment. Note that FIG. 15 shows a flowchart of processing executed by the image forming apparatus 1 in the case of the automatic setting mode. Upon receiving a print job, the video controller 110 decides on a density of an adhesive image Tk on the basis of a set type in step S50, and starts to generate image data in step S51. The set type in step S50 may be the same as or different from a set type used in a case where the automatic setting mode is OFF. In step S52, the engine controller 100 determines an actual type of a sheet S, and notifies the video controller 110 of the same.

In step S53, the video controller 110 determines whether the determined type notified by the engine controller 100 is the same as the set type in step S50. In a case where the determined type and the set type are the same, the image data that was started to be generated in step S51 is used in image formation in step S56. On the other hand, in a case where the set type and the determined type are different, the video controller 110 decides on the density of the adhesive image Tk (a decided density) on the basis of the determined type in step S54, and re-generates image data on the basis of the decided density in step S55. In this case, the image data generated in step S55 is used in image formation in step S56.

The video controller 110 determines whether image formation on all sheets S designated in the print job has been completed in step S57; in a case where the image formation has not been completed, processing from step S50 is repeated until the image formation is completed. Although image formation on the second surface is omitted also in FIG. 15, in a case where the adhesive image Tk is to be formed on the second surface, the same density as the first surface is used as the density of the adhesive image Tk.

Note that in a case where images are to be formed on N sheets S (where N is an integer equal to or larger than two) in the print job, the set type in image formation on the second or subsequent sheet S (a first type) can be the determined type of an immediately preceding sheet S. In general, the same sheet type is used in one print job; therefore, by using a previous determined type as the set type used in the second or subsequent step S50, the number of times image data is re-generated (step S55) can be reduced.

The set type in the first step S50 (the first type) can be a type set as a default, or a type set by the user. Alternatively, the set type used in the first step S50 can be decided based on a history of sheet types that were used in past printing. For example, the set type used in the first step S50 can be a sheet type that was used in an immediately preceding print job. Alternatively, the set type used in the first step S50 can be a sheet type that was used most in a predetermined time period of the past.

As described above, in the present embodiment, before a sheet type is determined, generation of image data is started assuming that a density of an adhesive image Tk is a density based on the set type. By appropriately setting the set type, the frequency at which image data is re-generated in step S55 can be lowered. As a result, an average time period from reception of a print job to actual image formation on a sheet S can be shortened.

### Third Embodiment

Next, a third embodiment will be described with a focus on the differences from the second embodiment. In the second embodiment, in the case of the automatic setting mode, image data is generated assuming that the density of the adhesive image Tk is the first density before determining an actual sheet type. Then, in a case where the decided density is not the first density, the video controller 110 re-generates image data with use of the decided density. The present embodiment is based on the premise that the same sheet type is used in one print job. Also, until the engine controller 100 determines a sheet type, image data is generated assuming that the density of the adhesive image Tk is a second density, whereas after the engine controller 100 has determined a sheet type, image data is generated based on the decided density.

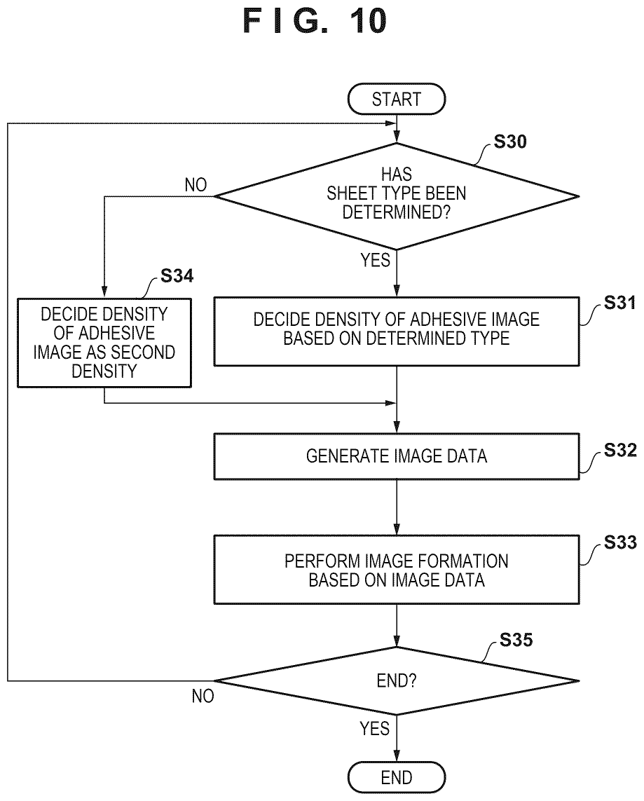

FIG. 10 is a flowchart of processing executed by the image forming apparatus 1 when the image forming apparatus 1 executes a print job that involves booklet creation in the processing apparatus 300. Note that the operations of the image forming apparatus 1 for a case where the automatic setting mode has not been set are similar to those of the first embodiment; therefore, processing for a case where the automatic setting mode has not been set is omitted in the flowchart of FIG. 10. In other words, FIG. 10 shows a flowchart of processing executed by the image forming apparatus 1 in the case of the automatic setting mode.

Upon receiving a print job, the video controller 110 determines whether the engine controller 100 has determined an actual type of a sheet S and already notified the video controller 110 of the same in step S30. In a case where the engine controller 100 has not determined the actual type of the sheet S yet, the video controller 110 decides on the second density as a density of an adhesive image Tk in step S34. On the other hand, in a case where the engine controller 100 has already determined the actual type of the sheet S, the video controller 110 uses a density based on the type determined by the engine controller 100 as a decided density in step S31. In step S32, the video controller 110 starts to generate image data. In a case where the image data includes adhesive image data for forming the adhesive image Tk, the density of the adhesive image Tk is the density decided in step S31 or S34. The image data generated in step S32 is used in image formation in step S33.

The video controller 110 determines whether image formation on all sheets S designated in the print job has been completed in step S35; in a case where the image formation has not been completed, processing from step S30 is repeated until the image formation is completed. Note that image formation on the second surface is omitted also in FIG. 10. In a case where the adhesive image Tk is to be formed on the second surface, if an actual sheet type has already been determined when generating image data to be formed on the second surface, the video controller 110 generates the image data assuming that the density of the adhesive image Tk is the decided density. Therefore, according to the present embodiment, the adhesive images Tk on the first surface and the second surface can have different densities in a case where an actual sheet type has not been determined yet when generating image data for the first surface, and an actual sheet type has already been determined when generating image data for the second surface. Note that it is permissible to adopt a configuration in which, in a case where an actual sheet type has not been determined yet when generating image data for the first surface, image data for the second surface may also be generated assuming that an actual sheet type has not been determined yet.

### MODIFIED EMBODIMENT

In the flowchart of FIG. 10, until an actual sheet type is determined, image data is generated assuming that the density of the adhesive image Tk is the second density, whereas after the actual sheet type has been determined, image data is generated assuming that the density of the adhesive image Tk is the decided density that is based on the actual sheet type. However, it is permissible to adopt a configuration in which, with respect to the first predetermined number of sheets in a print job, image data is generated assuming that the density of the adhesive image Tk is the second density, whereas with respect to the subsequent sheets, image data is generated based on the decided density. Furthermore, it is also permissible to adopt a configuration in which, in a case where the number of sheets on which images are formed in a print job is equal to or smaller than a predetermined number, image data is generated for all sheets assuming that the density of the adhesive image Tk is the second density, whereas in a case where the number of sheets is larger than the predetermined number, image data is generated after an actual sheet type has been determined, similarly to the first embodiment.

Note that in order to secure an adhesive force, the second density can be set at the maximum density. Alternatively, in order to secure an adhesive force, the second density can be set at a density equal to or higher than the maximum density within the densities indicated by the determination information. In other words, the second density can be set at the maximum density within the densities of the adhesive image Tk that are decided based on a plurality of types of sheets that can be used in the image forming apparatus 1, or a density higher than the maximum density.

As described above, according to the present embodiment, after an actual sheet type has been determined, the density of the adhesive image Tk formed on a sheet S can be controlled appropriately. Also, as generation of image data is started before an actual sheet type is determined, an average time period from reception of a print job to actual image formation on a sheet S can be shortened. Furthermore, an adhesive force can be secured by setting the second density, which is used until an actual sheet type is determined, to be equal to or higher than the maximum density within the densities indicated by the determination information.

### Fourth Embodiment

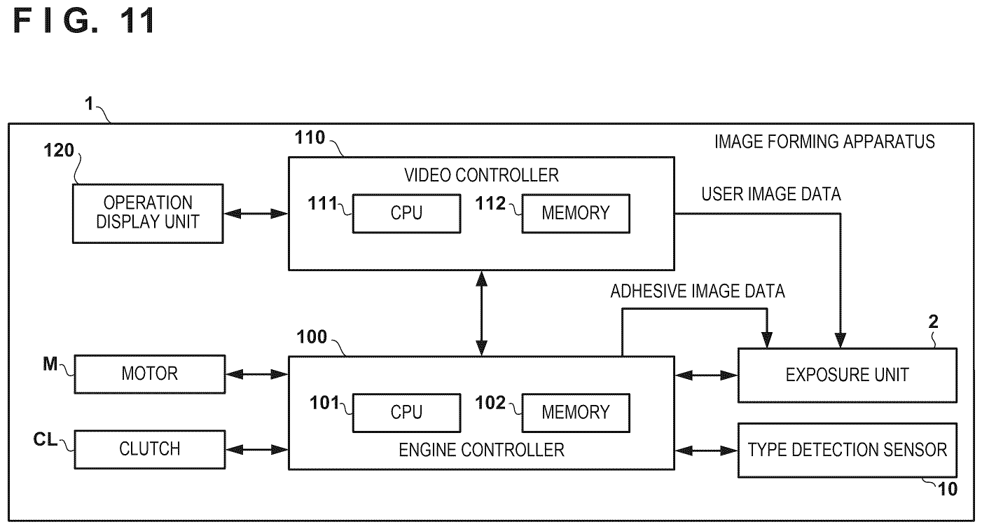

Next, a fourth embodiment will be described with a focus on the differences from the first embodiment to the third embodiment. In the first embodiment to the third embodiment, the video controller 110 generates image data for forming both of a user image and an adhesive image Tk. In the present embodiment, the video controller 110 generates user image data for forming a user image, and transmits the same to the exposure unit 2. On the other hand, the engine controller 100 generates adhesive image data for forming an adhesive image Tk, and transmits the same to the exposure unit 2. FIG. 11 shows a control configuration of the image forming apparatus 1 according to the present embodiment. In the present embodiment, as the engine controller 100 generates the adhesive image data for forming the adhesive image Tk, information indicating a plurality of patterns of the adhesive image Tk, as well as the determination information, is stored in advance in the memory 102.

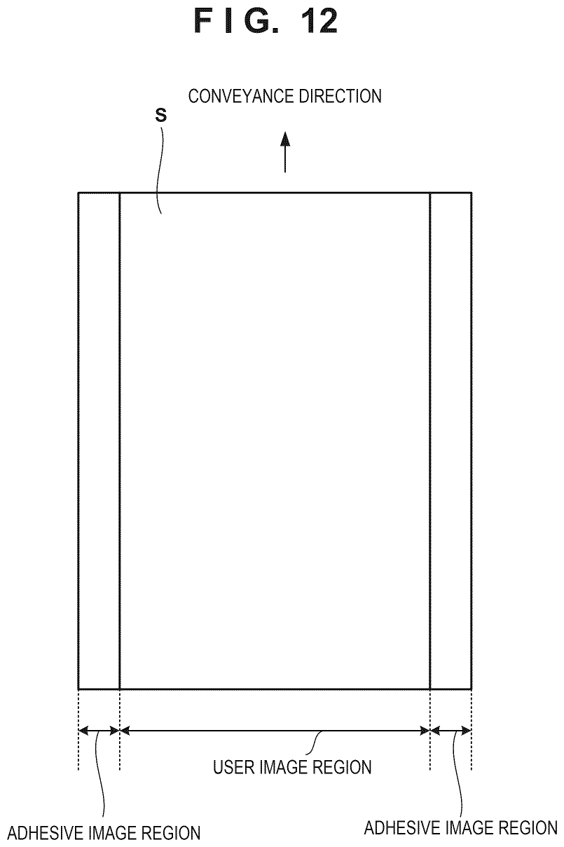

FIG. 12 is an explanatory diagram of regions on a sheet S. On the sheet S, a user image region in which a user image is formed, as well as two adhesive image regions located at both sides of the user image region in a direction perpendicular to the conveyance direction of the sheet S, is defined. The adhesive image regions are regions that include end portions of the sheet S in the direction perpendicular to the conveyance direction of the sheet S. The user image data generated by the video controller 110 is data for image formation in the user image region, and the adhesive image data generated by the engine controller 100 is data for image formation in the adhesive image regions.

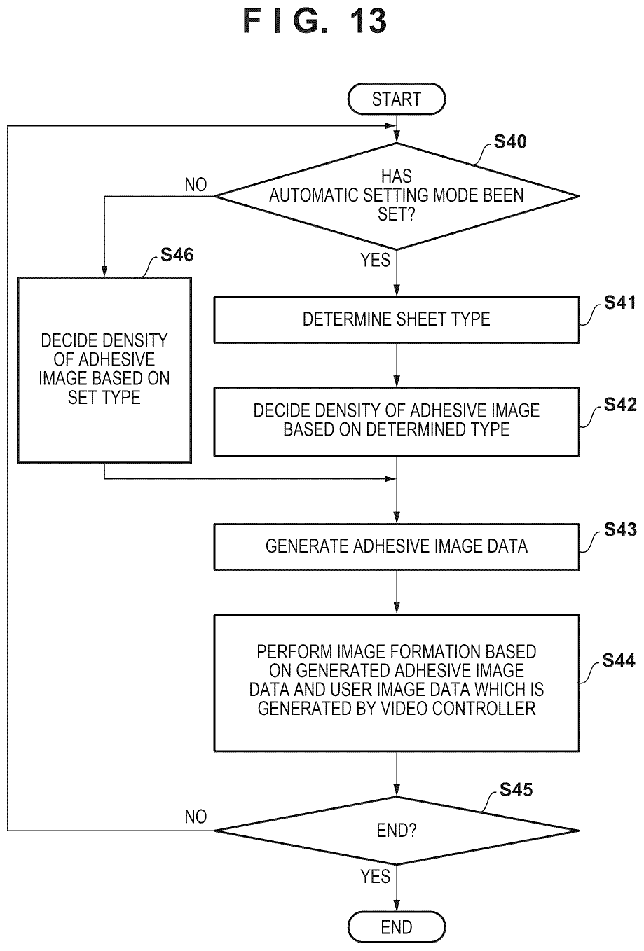

FIG. 13 is a flowchart of processing executed by the engine controller 100 when the image forming apparatus 1 executes a print job that involves booklet creation in the processing apparatus 300. In step S40, the engine controller 100 determines whether the automatic setting mode has been set. In a case where the automatic setting mode has not been set, the engine controller 100 decides on a density of an adhesive image Tk on the basis of a set type by a user in step S46. On the other hand, in a case where the automatic setting mode has been set, the engine controller 100 determines a type of a sheet S with use of the type detection sensor 10 in step S41, and decides on the density of the adhesive image Tk on the basis of the determined sheet type in step S42.

In step S43, the engine controller 100 generates adhesive image data in accordance with the density of the adhesive image Tk decided in step S46 or S42. Note that in the present embodiment, the video controller 110 generates user image data on the basis of image information received through a print job. When generation of the adhesive image data has been completed and the video controller 110 has provided a notification of completion of generation of the user image data, the engine controller 100 controls image formation on the first surface of the sheet S that is based on the user image data and the adhesive image data in step S44. Specifically, the engine controller 100 notifies the video controller 110 of a timing to transmit the user image data to the exposure unit 2, transmits the adhesive image data to the exposure unit 2, and also controls the light emission intensity of the exposure unit 2. Note that although not shown in FIG. 13 for simplicity of drawings, in a case where the adhesive image Tk is to be formed on the second surface of the sheet S, the density of the adhesive image Tk to be formed on the second surface is also the density decided in step S42 or S46. The engine controller 100 determines whether image formation on all sheets S designated in the print job has been completed in step S45; in a case where the image formation has not been completed, processing from step S40 is repeated until the image formation is completed.

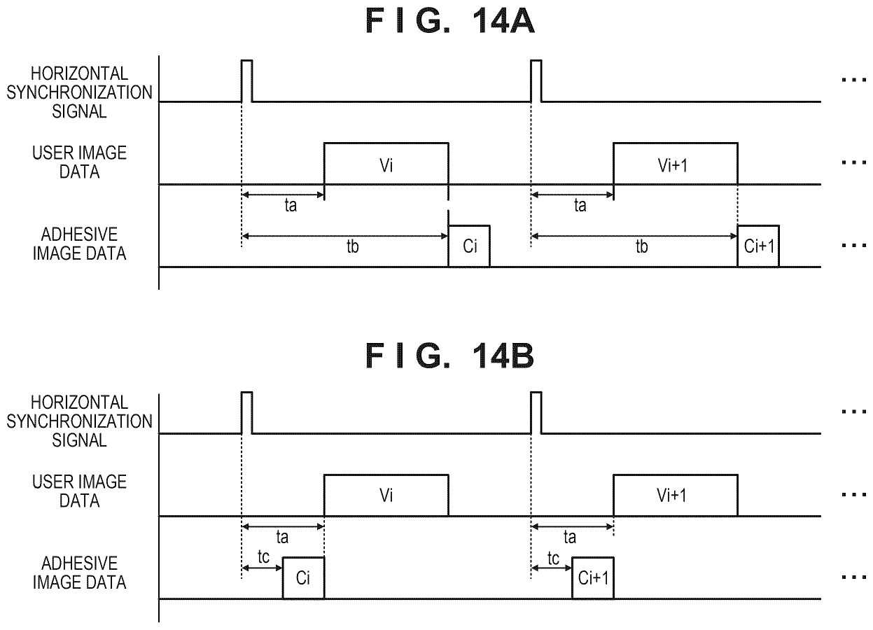

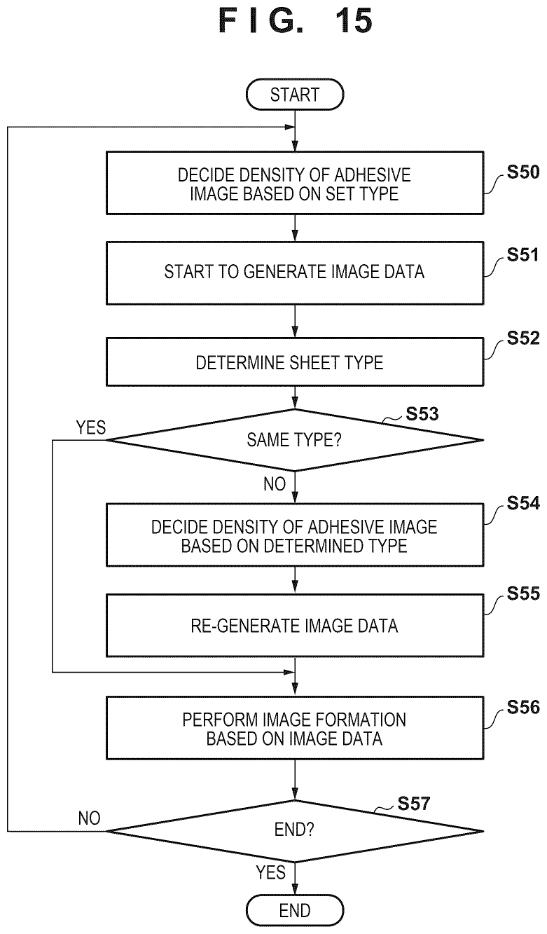

FIG. 14A and FIG. 14B are timing charts related to transmission of the user image data and the adhesive image data to the exposure unit 2 in image formation on a certain surface of one sheet. FIG. 14A shows a case where a user image is formed first, and an adhesive image Tk is formed thereafter, in exposing one line to light. FIG. 14B shows a case where an adhesive image Tk is formed first, and a user image is formed thereafter, in exposing one line to light. A horizontal synchronization signal is a signal transmitted by the engine controller 100 to the video controller 110. The horizontal synchronization signal is used to determine a formation start timing for one line, that is to say, a timing at which the video controller 110 transmits image data to the exposure unit 2.

In FIG. 14A, the formation start timing for the user image in the user image region is a time period ta after the timing of the horizontal synchronization signal. Therefore, when the time period ta has elapsed since the reception of the horizontal synchronization signal, the video controller 110 starts to transmit user image data Vi for the i^{th} line to the exposure unit 2. Also, in FIG. 14A, the formation start timing for the adhesive image Tk in the adhesive image regions is a time period tb after the timing of the horizontal synchronization signal. Therefore, when the time period tb has elapsed since the horizontal synchronization signal, the engine controller 100 starts to transmit adhesive image data Ci for the i^{th} line to the exposure unit 2.

In FIG. 14B, the formation start timing for the adhesive image Tk in the adhesive image regions is a time period tc after the timing of the horizontal synchronization signal. Therefore, when the time period tc has elapsed since the horizontal synchronization signal, the engine controller 100 starts to transmit adhesive image data Ci for the i^{th} line to the exposure unit 2. Also, in FIG. 14B, the formation start timing for the user image in the user image region is a time period ta after the timing of the horizontal synchronization signal. Therefore, when the time period ta has elapsed since the reception of the horizontal synchronization signal, the video controller 110 starts to transmit user image data Vi for the i^{th} line to the exposure unit 2.

As described above, according to the present embodiment, image data is divided into user image data for forming a user image, and adhesive image data for forming an adhesive image. Therefore, upon receiving a print job, the video controller 110 can start to generate the user image data without waiting for the result of determination about a sheet type. Also, in the case of the automatic setting mode, the engine controller 100 starts to generate the adhesive image data after determining a type of a sheet. For example, depending on the position of the adhesive image formed on a sheet S, an average time period from reception of a print job to actual image formation on the sheet S can be shortened. Note that in the flowchart of FIG. 13, generation of the adhesive image data is started after determining a sheet type, similarly to the first embodiment. However, it is permissible to adopt a configuration in which generation of image data is started before determining a sheet type, similarly to the second embodiment and the third embodiment.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-094509, filed Jun. 11, 2024, which is hereby incorporated by reference herein in its entirety.

What is claimed is:

1. An image forming apparatus, comprising:
an image forming unit configured to form an image on a sheet based on first image data; and
a control unit configured to generate the first image data and output the first image data to the image forming unit,
wherein the control unit is further configured to, in a case where the image including an adhesive image used as an adhesive is to be formed on the sheet in response to reception of a print job in which a plurality of sheets are bonded together by forming the image thereon, decide on a density of the adhesive image based on a type of the sheet.

2. The image forming apparatus according to claim 1, further comprising a sensor for determining the type of the sheet,
wherein the control unit is further configured to determine the type of the sheet with use of the sensor.

3. The image forming apparatus according to claim 2, wherein
the sensor is configured to detect a basis weight of the sheet and a surface property of the sheet, and
the control unit is further configured to determine the type of the sheet based on the basis weight of the sheet and the surface property of the sheet detected by the sensor.

4. The image forming apparatus according to claim 2, wherein
the control unit is further configured to, in a case where the image including the adhesive image is to be formed on the sheet, decide on the density of the adhesive image based on a determined type of the sheet that has been determined with use of the sensor, and generate the first image data after deciding on the density of the adhesive image.

5. The image forming apparatus according to claim 2, wherein
the control unit is further configured to, in a case where the image including the adhesive image is to be formed on the sheet, generate second image data while assuming that the density of the adhesive image is a first density before determining the type of the sheet with use of the sensor, and when the density of the adhesive image based on a determined type of the sheet that has been determined with use of the sensor is different from the first density, decide on the density of the adhesive image based on the determined type and generate the first image data.

6. The image forming apparatus according to claim 5, wherein
the control unit is further configured to, in a case where the density of the adhesive image based on the determined type is the same as the first density, output the second image data as the first image data to the image forming unit.

7. The image forming apparatus according to claim 5, wherein
in image formation on a first sheet among the plurality of sheets, the first density is a density that has been set in advance, and in image formation on a second or subsequent sheet among the plurality of sheets, the first density is a density based on the determined type of the sheet on which image formation has been performed immediately therebefore.

8. The image forming apparatus according to claim 2, wherein
the control unit is further configured to, in a case where the image including the adhesive image is to be formed on the sheet, generate second image data while assuming that the type of the sheet is a first type before determining the type of the sheet with use of the sensor, and when a determined type of the sheet that has been determined with use of the sensor is different from the first type, decide on the density of the adhesive image based on the determined type and generate the first image data.

9. The image forming apparatus according to claim 8, wherein
the control unit is further configured to, in a case where the determined type is the same as the first type, output the second image data as the first image data to the image forming unit.

10. The image forming apparatus according to claim 8, wherein
in image formation on a first sheet among the plurality of sheets, the first type is a type that has been set in advance, and in image formation on a second or subsequent sheet among the plurality of sheets, the first type is the determined type of the sheet on which image formation has been performed immediately therebefore.

11. The image forming apparatus according to claim 2, wherein
the control unit is further configured to, in image formation on the plurality of sheets, generate the first image data while assuming that the density of the adhesive image is a second density before determining the type of the sheet with use of the sensor, and decide on the density of the adhesive image based on a determined type that has been determined with use of the sensor and generate the first image data after determining the type of the sheet with use of the sensor.

12. The image forming apparatus according to claim 2, wherein
the control unit is further configured to, in a case where the number of the plurality of sheets is equal to or smaller than a predetermined number, generate the first image data while assuming that the density of the adhesive image is a second density with respect to each of the plurality of sheets, and
the control unit is further configured to, in a case where the number of the plurality of sheets is larger than the predetermined number, generate the first image data while assuming that the density of the adhesive image is the second density with respect to the predetermined number of sheets on which the image is to be formed first among the plurality of sheets, and decide on the density of the adhesive image based on a determined type of the sheet that has been determined with use of the sensor and generate the first image data with respect to remaining sheets.

13. The image forming apparatus according to claim 2, wherein
the control unit is further configured to, in a case where the number of the plurality of sheets is equal to or smaller than a predetermined number, generate the first image data while assuming that the density of the adhesive image is a second density with respect to each of the plurality of sheets, and
the control unit is further configured to, in a case where the number of the plurality of sheets is larger than the predetermined number, decide on the density of the adhesive image based on a determined type of a first sheet that has been determined with use of the sensor and generate the first image data with respect to each of the plurality of sheets.

14. The image forming apparatus according to claim 11, wherein
the second density is equal to or higher than a maximum density among densities of the adhesive image that are decided respectively for a plurality of types of the sheet that are used in the image forming apparatus.

15. The image forming apparatus according to claim 1, wherein
the first image data includes third image data for forming an image in a first region of the sheet, and fourth image data for forming an image in second regions that are located at both sides of the first region in a direction perpendicular to a conveyance direction of the sheet,
the adhesive image is formed in the second regions, and an image which is included in the image formed on the sheet and which is different from the adhesive image is formed in the first region, and
the control unit includes a first controller that generates the third image data, and a second controller that generates the fourth image data.

16. The image forming apparatus according to claim 1, wherein
the control unit is further configured to, in a case where a mode that uses a type set by a user has been set, decide on the density of the adhesive image based on the type set by the user and generate the first image data.

17. An image forming system, comprising:
an image forming apparatus; and
a processing apparatus in which sheets having an image formed thereon by the image forming apparatus are loaded in sequence, and which executes adhesion processing with respect to a plurality of sheets loaded therein,
wherein
the image forming apparatus includes
an image forming unit configured to form the image on the sheets based on first image data; and
a control unit configured to generate the first image data and output the first image data to the image forming unit, and
the control unit is further configured to, in a case where the image including an adhesive image used as an adhesive is to be formed on the sheets in response to reception of a print job that executes adhesion processing with respect to the plurality of sheets in the processing apparatus, decide on a density of the adhesive image based on a type of the sheets.
